(19) United States
(12) Patent Application Publication
(10) Pub. No.: US 2010/0113816 A1
(43) Pub. Date: May 6, 2010

(54) METHOD FOR PREPARTION OF SUBSTITUTED ADAMANTYLARYMAGNESIUM HALIDES

(76) Inventors: Ivars Kalvinsh, Ikskile (LV); Aleksandrs Chernobrovijs, Olaine (LV); Vyacheslav Tribulovich, Sankt-Peterburg (RU); Vladimir Labeish, Sankt-Peterburg (RU)

Correspondence Address: THE FIRM OF HUESCHEN AND SAGE, SEVENTH FLOOR, KALAMAZOO BUILDING, 107 WEST MICHIGAN AVENUE, KALAMAZOO, MI, 49007, US

(21) Appl. No.: 12/448,671

(22) PCT Filed: Dec. 28, 2007
(86) PCT No.: PCT/EP2007/064648

§ 371 Date: Dec. 10, 2009

(30) Foreign Application Priority Data
Dec. 29, 2006 (LV) P-06-151

(51) Int. Cl. C07F 3/02; C07F 7/08

(52) U.S. Cl. 556/486; 568/634

(57) ABSTRACT

The present invention concerns fine organic synthesis, particularly the method for preparing of substituted adamantylarylmagnesium halides.

The known methods for preparing Grignard's reagent from substituted adamantylarylhalide give very low yeld of the desired product. Substituted adamantylarylhalides are active intermediates that by interacting with various electrophiles provide for a wide range of biologically active compounds.

The aim of current invention was to develop a method for preparing substituted adamantylarylmagnesium halides. The aim was attained adding lithium chloride in the Grignard's reagent synthesis by acting on is magnesium metal in dry tetrahydrofuran under argon by substituted adamantylarylhalide.

It was demonstrated that adding lithium chloride to adamantylarylhalide within a range from 1:1 to 1:2 provides for stable high yield of the desired end product.

The present invention concerns fine organic synthesis, particularly the method for preparing of substituted adamantylarylmagnesium halides.

Organomagnesium compounds are especially important in contemporary preparative organic chemistry. Since Grignard's discovery in 1900 the methods for preparing and further transformation of these synthetic intermediates are in continuous development and expansion.

The standard preparative method for preparing organomagnesium compounds (Grignard's reagents) is direct interaction of organic halides with metallic magnesium in an aprotic polar solvent, like tetrahydrofuran (THF) or diethyl ether [C. T. [symbol] , A. H. [symbol] [symbol] [symbol] - [symbol] [symbol] [symbol] , [symbol] , [symbol] , [symbol] , [symbol] . [symbol] . AH CCCP M. 1963, 14-27].

The aim of the present invention is a development of method for preparing substituted adamantylarylmagnesium halides, satisfying the following requirements:
stable high yields of the product—possibility of substantial scaling up
simple technology.

The compounds produced are active intermediates that can interact with various electrophiles to yield substrates useful for the synthesis of a wide range of biologically active compounds [Charpentier, B.; Bernardon, J.-M.; Eustache, J. et al. Synthesis, structure-affinity relationships, and biological activities of ligands binding to retinoic acid receptor subtypes. J. Med. Chem. 1995, 38 (26), 4993-5006. Cincinelli, R.; Dallavalle, S.; Nannei, R. Synthesis and structure-activity relationships of a new series of retinoid-related biphenyl-4-ylacrylic acids endowed with antiproliferative and proapoptotic activity. J. Med. Chem. 2005, 48 (15), 4931-4946. Pfahl, M.; Tachdjian, C. et al. Heterocyclic derivatives for the treatment of cancer and other proliferative diseases. US 2002/0143182 A1]

An important representative of substituted adamantyl-arylmagnesium halides is 3-(1-adamantyl)-4-methoxyphenylmagnesium bromide

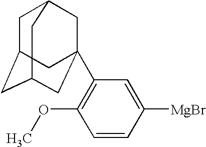

that is used in synthesis of 6-[3-(1-adamantyl)-4-methoxyphenyl]-2-naphtoic acid (adapalene):

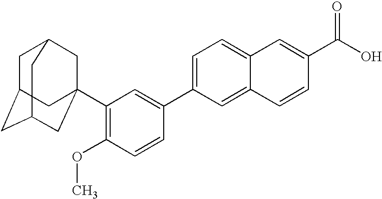

Adapalene is a pharmaceutical widely used in dermatology as efficient agent for treating acne vulgaris [Waugh, J.; Noble, S.; Scott, L. Spotlight on adapalene in acne vulgaris. J. Am. J. Clin. Dermatol. 2004, 5 (5), 369-371; Jain, S. Topical tretinoin or adapalene in acne vulgaris:

No less important representative is 3-(1-adamantyl)-4-(tert-butyldimethylsilyloxy)phenylmagnesium bromide

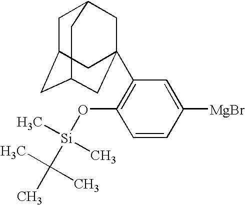

or 3-(1-adamantyl)-4-benzyloxyphenylmagnesium bromide,

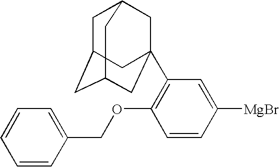

that is used in synthesis of 6-[3-(1-adamantyl)-4-hydroxyphenyl]-2-naphtoic acid (AHPN, CD 437):

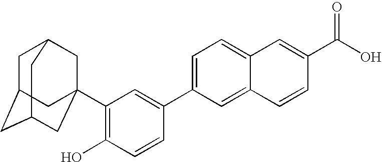

3-(1-Adamantyl)-4-(tert-butyldimethylsilyloxy)phenylmagnesium bromide or 3-(1-adamantyl)-4-benzyloxy-phenylmagnesium bromide can also be used for synthesis of 4-[3-(1-adamantyl)-4-hydroxyphenyl]-3-chlorocynnamic acid (3-Cl-AHPC),

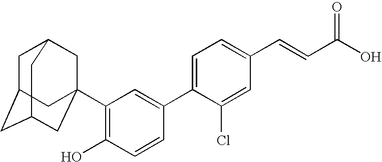

that like 6-[3-(1-adamantyl)-4-hydroxyphenyl]-2-naphtoic acid (AHPN, CD 437) is patented as anti-tumour agent [Dawson, M.; Fontana, J.; Zhang, X. et al. Induction of apoptosis in cancer cells. WO 03/048101 A1].

Synthesis of substituted adamantylarylmagnesium halides containing electrodonor substituents in the aromatic ring by classical method, i.e., by interaction or arylhalide with metallic magnesium in aprotic polar solvent, like THF or diethyl ether, gives yields not exceeding 11%. The main reaction product results from reduction of arylhalide. Thus 2-(1-adamantyl)-4-bromoanisole yields 2-(1-adamantyl)anisole in 78% yield (see Example 1).

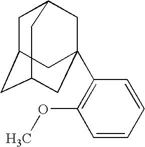

Gass chromatographic analysis of reaction mixture confirmed complete conversion of 2-(1-adamantyl)-4-bromoanisole. It means that the starting material is reacting very efficiently with metallic magnesium under the conditions of classic Grignard's reaction.

Similar experiments with 2-(1-adamantyl)-5-bromoanisole yielded similar results (see Example 2)

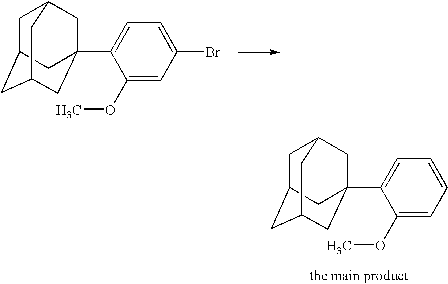

and with 3-(1-adamantyl)-5-bromovertrol (see Example 3).

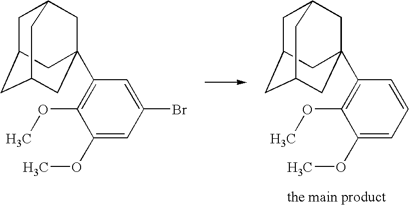

The reduction of adamantylaryl halide as the main reaction of starting material under the conditions of Grignard's reaction may be the result of the instability of the adamantylarylmagnesium halide or the consequence of low reactivity of the Grignard's reactant with the employed electrophile.

Changing the temperature and reaction time in preparing the Grignard's reactant practically did not lead tod to any substantial change in composition of reaction products. See Example 4. The addition method (simultaneous addition of the starting arylbromide and dibromoethane), [D. E. Pearson et al., J. Org. Chem., 24, 504 (1959)] did not give positive result. See Example 5

Changing the organic electrophile did not substantially change the rate of products: reduction product/substituted adamantylarylmagnesium bromide (See Example 6). Use of inorganic electrophile like D₂SO₄-D₂O, preventing the possible interaction of adamantylarylmagnesium halide with organic electrophile yielded a similar result. Thus decomposing of Grignard's reagent prepared from 2-(1-adamantyl)-4-bromoanisole with a mixture of D₂SO₄-D₂O yields a mixture of products where the content of deuterated 2-(1-adamantyl)-anisole,

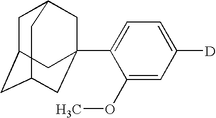

being the end product in this case, is 9% (NMR data, see Example 7).

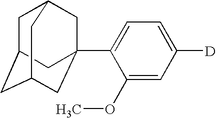

These results show that Grignard's reagent, formed from 2-(1-adamantyl)-4-bromoanisole, is an unstable substance and undergoes a formal reduction before interaction with any electrophile.

The closest prior art to the present invention is the exchange method for preparing organomagnesium reagent [Krasovskiy, A.; Knochel, P. A LiCl-mediated Br/Mg exchange reaction for the preparation of functionalized aryl—and heteroarylmagnesium compounds from organic bromides. Angew. Chem. Int. Ed. 2004, 43 (25), 3333-3336; Knochel, P. Krasovskiy, A. Method of preparing organomagnesium compound. EP 1582523 (2005). Krasovskiy, A.; Straub, B. F.; Knochel, P. Highly efficient reagents for Br/Mg exchange. Angew. Chem. Int. Ed. 2006, 45 (1), 159-162.].

This method is based on preparing of AlkMgCl.LiCl or Alk₂Mg.LiCl complexes and their interaction with substituted aryl or heteroaryl halides.

Nevertheless the reaction of 2-(1-adamantyl)-4-bromonisole (See Example 8—according to prior art) and 3-(1-adamantyl)-5-bromoveratrol (See Example 9—according to prior art) with iso-PrMgCl LiCl under the conditions given in prior art, gave a conversion of 6 to 9% within 2 days time.

Thus the experimental data confirmed both the instability of substituted adamantylarylmagnesium halide and the low reactivity of substituted adamantylarylmagnesium halide in the exchange synthesis reaction, using iso-PrMgCl LiCl.

While investigating the preparation of arylmagnesium halides with electrodonor substituents in the ring, some authors [Krasovskiy, A.; Straub, B. F.; Knochel, P. Highly efficient reagents for Br/Mg exchange. Angew. Chem. Int. Ed. 2006, 45 (1), 159-162] have used reactants with higher reactivity in the exchange synthesis of organomagnesium compounds, therefore the equilibrium in Schlenk's equation

2 iso-PrMgCl LiCl⇄iso-Pr₂MgCl+MgCl₂+LiCl

was shifted to iso-Pr₂MgCl.LiCl or dialkylmagnesium derivative by capturing MgCl₂ with various reactants, like dioxan.

Using this method in preparing the organomagnesium derivative from 2-(1-adamantyl)-4-bromoanisole (See Example 10—according to prior art) gave ar 13% conversion after 2 days time.

The results obtained show that the most active reactant in preparing organometallic derivatives from adamantylarylhalides is magnesium metal, but the adamantylarylmagnesium halide formed should be stabilized to prevent further unwanted reactions.

The previously stated aim, i.e., developing of an efficient and technologically feasible method for preparing substituted adamantyl-arylmagnesium halides was attained, using lithium chloride in the process of synthesizing the Grignard's reagent—when reacting magnesium metal with substituted adamantylarylhalides under argon in anhydrous THF. (See Examples 10-41).

The present method for preparing substituted adamantyl-arylmagnesium halides is based on assumption that under the standard conditions of organomagnesium synthesis, i.e., acting by aryl halides on magnesium metal, the addition of lithium chloride stabilizes the substituted adamantylarylmagnesium halide by complex formation and prevents further unwanted reactions but does not fatally depress the reactivity of the substituted adamantylarylmagnesium halide.

The method according to the present invention is illustrated by the following examples.

### EXAMPLE 1

Into a 1 L flask equipped with a stirrer, a reflux condenser and a dropping funnel 8 g (0.33 M) of magnesium filings are introduced and 200 mL of dry tetrahydrofuran added. The air in the flask is displaced by argon and all further operations conducted under a slight stream of the inert gas. Under vigorous stirring 11 g (5 mL, 0.06 M) of 1,2-dibromoethane is added. After the vigorous reaction had subsided, the hot reaction mixture is treated with a solution of 50 g (0.16 M) 2-(1-adamantyl)-4-bromoanisole in 400 mL of dry tetrahydrofuran with such speed that a slight reflux is supported. After the adding of all solution of 2-(1-adamantyl)-4-bromoanisole, the reaction mixture is refluxed for another 30 min. Stirring is discontinued and the solution of the prepared Grignard's reagent decanted from the residual magnesium into a conical flask with ground stopper flushed in advance with argon.

For further functionalization reactions trimethylborate, a standard reactant for preparing phenylboronic acids was used.

In a 1 L flask equipped with a stirrer, a reflux condenser and a dropping funnel a solution of 33 g (36 mL, 0.35 M) of trimethylborate in 100 mL of dry tetrahydrofuran is prepared, the solution cooled to −50° C. and under vigorous stirring the solution of the Grignard's reagent is added within 30 min at −40to −50° C.

The reaction mixture is decomposed with a solution of 50 mL of hydrochloric acid in 50 mL water with vigorous stirring without external cooling. The mixture is transferred to separating funnel and the water and organic layers separated. To the water layer 200 mL of water is added and then extracted twice with 100 mL of diethylether. The pooled organic solutions are dried on anhydrous sodium sulfate, the solvents removed in vacuo at about 50° C. in the water bath.

The residue is treated with 200 mL of hexane and left in the freezer overnight. The precipitate is filtered off, washed with cold ethyl acetate and is dried at 100° C. 3-(1-adamantyl)-4-methoxyphenylboronic acid with m.p. ˜300° C. is obtained, yield 2.5 g (5.7%).

The gas chromatographic analysis of the reaction mixture showed one main product. The yield, according to gas chromatography data is 78%.

The compound was isolated and identified as 2-(1-adamantyl)anisole.

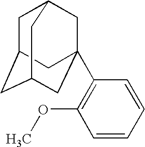

The preparative yield is 67%, m.p. 100-102° C.

### EXAMPLE 2

Reaction is performed as described in Example 1. As the adamantylarylhalide 50 g (0.16 M) of 2-(1-adamantyl)-5-bromoanisole is used. 4-(1-adamantyl)-3-methoxyphenylboronic acid, 3 g (6.8%) is obtained. The gas chromatography data give the yield 2-(1-adamantyl)anisole as 81%.

The formal reduction product of 2-(1-adamantyl)-5-bromoanisole was isolated and its identity with 2-(1-adamantyl)anisole obtained in Example 1 confirmed, thus confirming the structure ascribed.

### EXAMPLE 3

Reaction is performed as described in Example 1. As the adamantylarylhalide 56 g (0.16 M) of 3-(1-adamantyl)-5-bromoveratrol is used. 3-(1-adamantyl)-4,5-methoxyphenylboronic acid, 3.7 g (7.3%) is obtained. The gas chromatography data give the yield 3-(1-adamantyl)veratrol as 74%.

### EXAMPLE 4

Reaction is performed as described in Example 1. Variation of temperature and reaction time did not change the result.

### EXAMPLE 5

Reaction is performed as described in Example 1. Simultaneous addition of arylhalide and 1,2-dibromoethane did not change the result.

Use of benzaldehyde as electrophile that quantitatively reacts with the arylmagnesium halide yielding arylphenylmethanol gave the same result. The reaction mixture, according to gas chromatography data contains 70-75% of adamantylbenzene derivative and 3-11% of the expected arylphenylmethanol

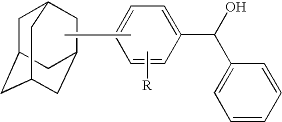

### EXAMPLE 6

Grignard's reagent was prepared from 51 g (0.16 M) of 2-(1-adamantyl)-4-bromoanisole as in Example 1. In the next step into a 1 L flask equipped with a stirrer, a reflux condenser and a dropping funnel 17 g (16.5 mL, 0.16 M) of benzaldehyde and 100 mL of dry tetrahydrofuran was introduced, the solution cooled to 0° C. and under stirring the solution of the Grignard's reagent added within 10 min. The mixture was left for 16 h in a refrigerator at about 0° C.

The reaction mixture is decomposed with a solution of 25 mL of hydrochloric acid in 25 mL of water with vigorous stirring without external cooling. The mixture is transferred to separating funnel and the water and organic layers separated, the water layer extracted with 2 portions of 100 mL of diethyl ether. The pooled organic layers were dried over sodium sulfate.

The yield of 3-(1-adamantyl)-4-methoxyphenylmethanol

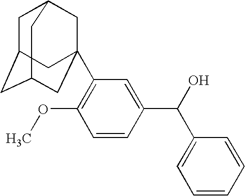

according to gas chromatography data is 11%.

### EXAMPLE 7

Grignard's reagent was prepared from 10 g (0.032 M) of 2-(1-adamantyl)-4-bromoanisole as in Example 1. As the electrphile for functionalization and identification a mixture of D₂SO₄-D₂O was used.

The reaction mixture is decomposed with a solution of 2 mL of D₂SO₄ in 10 mL of heavy water with vigorous stirring without external cooling. The mixture is transferred to separating funnel and the water and organic layers separated, the water layer extracted with 2 portions of 50 mL of diethyl ether. The pooled organic layers were dried on sodium sulfate and the solvent removed completely in vacuo.

### EXAMPLE 8

### According to Prior Art

Into a 200 mL flask with a magnetic stirrer and dropping funnel 5.14 g (0.016 M) of 2-(1-adamantyl)-4-bromoanisole and 60 mL of dry tetrahydrofuran is introduced. The air in the flask is displaced by argon and all further operations conducted under a slight stream of the inert gas. The mixture is cooled to −5° C. and 3 Eq of 0.5 M iso-PrMgCl LiCL solution in tetrahydrofuran added, keeping the reaction temperature within −5-0° C. range.

iso-PrMgCl LiCL solution in tetrahydrofuran was prepared beforehand, its concentration determined by titration according to [Krasovskiy, A.; Knochel, P. Convenient titration method for organometallic zinc, magnesium, and lanthanide reagents. Synthesis 2006, 5, 890-891].

After adding the solution of iso-PrMgCl LiCL in tetrahydrofuran, the reaction mixture was kept for 1 h at 0° C. and left at room temperature for 48 h.

The gas chromatography data give the conversion of 2-(1-adamantyl)-4-bromoanisole as 9%.

### EXAMPLE 9

### According to Prior Art

Reaction is performed as described in Example 8. As the adamantylarylhalide 5.62 g (0.016 M) of 3-(1-adamantyl)-5-bromoveratrol is used.

The gas chromatography data give the conversion of 3-(1-adamantyl)-5-bromoveratrol as 6%.

If the reaction is performed in a mixture of tetrahydrofuran and dioxan (dioxan 10% v/v), the conversion of adamantylarylhalide is increased only slightly.

### EXAMPLE 10

### According to Prior Art

Reaction is performed as described in Example 8. As the solvent for 5.14 g (0.016 M) of 2-(1-adamantyl)-4-bromoanisole a mixture of 54 mL of tetrahydrofuran and 6 mL dioxan is used.

The gas chromatography data give the conversion of 2-(1-adamantyl)-4-bromoanisole as 13%.

### EXAMPLE 11

Into a 100 mL flask equipped with a magnetic stirrer, a reflux condenser and a dropping funnel 1 g (0.042 M) of magnesium filings are introduced and 20 mL of dry tetrahydrofuran added. Pulverized anhydrous lithium chloride, 0.81 g (0.019 M) is added. The air in the flask is displaced by argon and all further operations conducted under a slight stream of the is inert gas. Under vigorous stirring 1.1 g (0.5 mL, 0.006 M) of 1,2-dibromoethane is added. After the vigorous reaction had subsided, the hot reaction mixture is treated dropwise within 30 min with 5.14 g (0.016 M) of 2-(1-adamantyl)-4-bromoanisole in 40 mL of dry tetrahydrofuran, keeping the reaction mixture at 55-60° C. The mixture is then kept at slight reflux for another 30 min. Stiring is discontinued and the solution of the prepared Grignard's reagent decanted from the residual magnesium into a conical flask with ground stopper flushed in advance with argon. The flask is closed with a stopper and kept at 0° C. for 2 h.

Into a 250 mL flask equipped with a magnetic stirrer, a reflux condenser and a dropping funnel a solution of 3.4 g (3.3 mL, 0.032 M) of benzaldehyde in 20 mL of dry tetrahydrofuran is introduced, the solution cooled to 0° C. and under constant stirring the solution of the Grignard's reagent is added within 10 min. The mixture is left in a refrigerator at about 0° C. for 16 h.

The reaction mixture is decomposed with a solution of 5 mL of HCl in 5 mL of water with vigorous stirring without external cooling. The mixture is transferred to separating funnel and the water and organic layers separated, the water layer extracted with 2 portions of 20 mL of diethyl ether. The pooled organic layers were dried over sodium sulfate. 3-(1-Adamantyl)-4-methoxyphenyl)phenylethanol, 88% (gas chromatography data) is obtained.

Experimentally the optimal rate of the substituted adamantylarylhalide and lithium chloride in the Grignard's reaction was determined as 1:1.2. The results in Table 1 (Examples 4, 10, 11-12) show that increasing of the molar rate of lithium chloride from 0.1 to 1.2 the yield of the Grignard's reagent increases, but the further increase to 2 equivalents does not substantially increase the yield of Grignard's reagent.

TABLE 1
The influence of the rate of arylhalide and lithium chloride on the
yield of arylmagnesium halide

| | | Yield, % | | | | | | |
|---|---|---|---|---|---|---|---|---|
| | | | 0.1 | 0.5 | 1 | 1.2 | 1.5 | 2 |
| | | No | Eq | Eq | Eq | Eq | Eq | Eq |
| Nr. | Arylhalide, 1 Eq | LiCl | LiCl | LiCl | LiCl | LiCl | LiCl | LiCl |
| 1 | 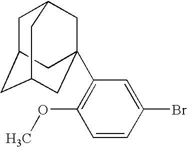 | 11 | 16 | 30 | 75 | 88 | 87 | 85 |
| 2 | 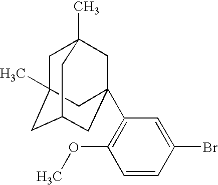 | 13 | 18 | 34 | 74 | 89 | 89 | 84 |

### EXAMPLE 12

Reaction is performed as described in Example 11. The Grignard's reagent is produced with 0.07 g (0.0016 M, 1 eq.) of pulverized anhydrous LiCl. The molar rate of substrate:LiCl is 1:0.1. Yield, according to gas chromatography data is 16%.

### EXAMPLE 13

Reaction is performed as described in Example 11. The Grignard's reagent is produced with 0.34 g (0.008 M) of pulverized anhydrous LiCl. The molar rate of substrate:LiCl is 1:0.5. Yield, according to gas chromatography data is 30%.

### EXAMPLE 14

Reaction is performed as described in Example 11. The Grignard's reagent is produced with 0.68 g (0.016 M) of pulverized anhydrous LiCl. The molar rate of substrate: LiCl is 1:1. Yield, according to gas chromatography data is 75%.

### EXAMPLE 15

Reaction is performed as described in Example 11. The Grignard's reagent is produced with 1.02 g (0.024 M) of pulverized anhydrous LiCl. The molar rate of substrate:LiCl is 1:1.5. Yield, according to gas s chromatography data is 87%.

### EXAMPLE 16

Reaction is performed as described in Example 11. The Grignard's reagent is produced with 1.36 g (0.032 M) of pulverized anhydrous LiCl. The molar rate of substrate:LiCl is 1:2. Yield, according to gas chromatography data is 85%.

### EXAMPLE 17

Reaction is performed as described in Example 11. As the starting adamantylarylhalide 5.58 g (0.016 M) of 2-(3,5-dimethyladamantyl)-4-bromoanisole is used. Reaction was performed without adding LiCl. (3-[1-(3,5-dimethyladamantyl)-4-methoxyphenyl)phenylethanol, 13% (gas chromatography data) is obtained.

### EXAMPLE 18

Reaction is performed as described in Example 11. As the starting adamantylarylhalide 5.58 g (0.016 M) of 2-(3,5-dimethyladamantyl)-4-bromoanisole is used. Pulverized anhydrous lithium chloride, 0.07 g (0.0016 M) is used in the Grignard's reaction. The molar rate of substrate:LiCl is 1:0.1. Yield, according to gas chromatography data is 18%.

### EXAMPLE 19

Reaction is performed as described in Example 18. The Grignard's reagent is produced with 0.34 g (0.008 M) of pulverized anhydrous LiCl. The molar rate of substrate:LiCl is 1:0.5. Yield, according to gas chromatography data is 34%.

### EXAMPLE 20

Reaction is performed as described in Example 18. The Grignard's reagent is produced with 0.68 g (0.016 M) of pulverized anhydrous LiCl. The molar rate of substrate:LiCl is 1:1. Yield, according to gas chromatography data is 74%.

### EXAMPLE 21

Reaction is performed as described in Example 18. The Grignard's reagent is produced with 0.81 g (0.019 M) of pulverized anhydrous LiCl. The molar rate of substrate:LiCl is 1:1.2. Yield, according to gas chromatography data is 89%.

### EXAMPLE 22

Reaction is performed as described in Example 18. The Grignard's reagent is produced with 1.02 g (0.024 M) of pulverized anhydrous LiCl. The molar rate of substrate:LiCl is 1:1.5. Yield, according to gas chromatography data is 89%.

### EXAMPLE 23

Reaction is performed as described in Example 18. The Grignard's reagent is produced with 1.36 g (0.032 M) of pulverized anhydrous LiCl. The molar rate of substrate:LiCl is 1:2. Yield, according to gas chromatography data is 84%.

The present method for preparation of adamantylarylmagnesium halides was tested with various substrates. The molar rate of adamantylarylhalide and lithium chloride used was 1:1.2. As the electrophile benzaldehyde was used. The yield was determined by gas chromatography (Examples 11, 21, 24-43). The results are given in Table 2.

TABLE 2
The yield of adamantylarylhalide at the molar rate of
adamantylarylhalide and lithium chloride 1:1.2

| Nr. | Ex.* | Arylmagnesium halide | Arylphenylcarbinol | Yield, %** |
|---|---|---|---|---|
| 1 | 11 | 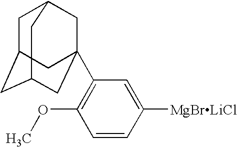 | 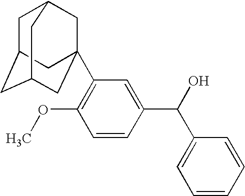 | 88 |
| 2 | 21 | 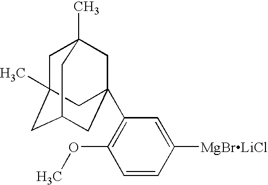 | 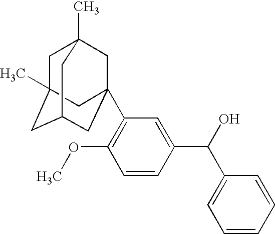 | 89 |
| 3 | 24 | 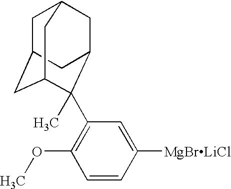 | 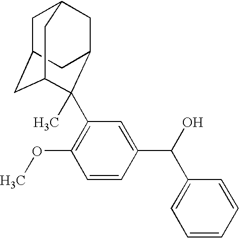 | 84 |
| 4 | 25 | 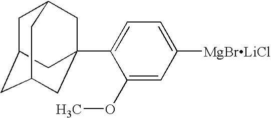 | 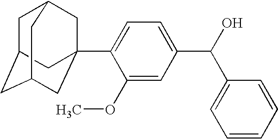 | 92 |
| 5 | 26 | 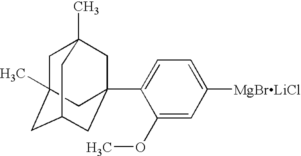 | 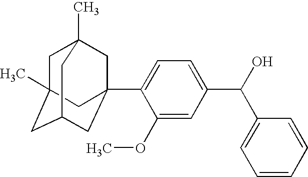 | 91 |
| 6 | 27 | 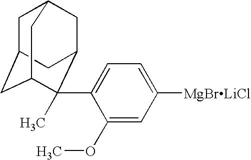 | 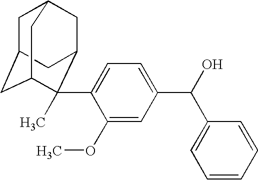 | 90 |
| 7 | 28 | 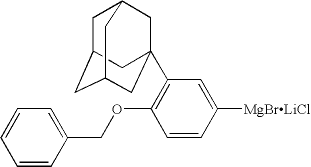 | 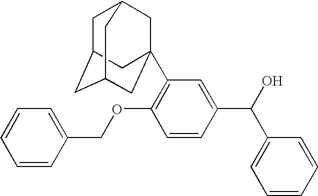 | 92 |
| 8 | 29 | 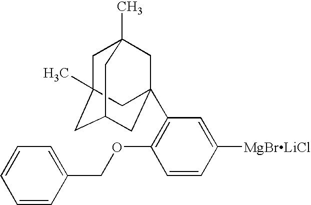 | 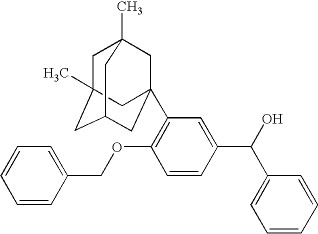 | 90 |
| 9 | 30 | 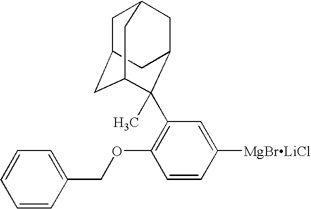 | 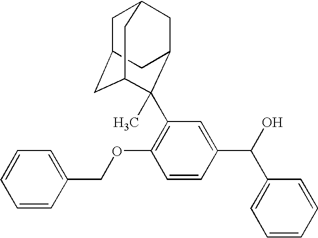 | 88 |
| 10 | 31 | 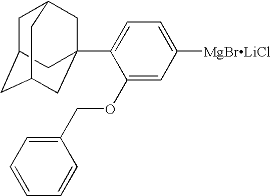 | 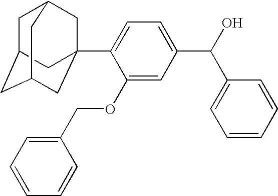 | 92 |
| 11 | 32 | 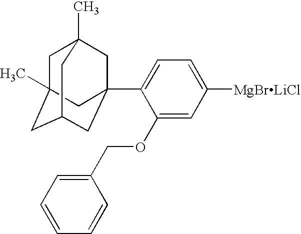 | 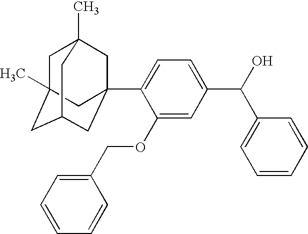 | 87 |
| 12 | 33 | 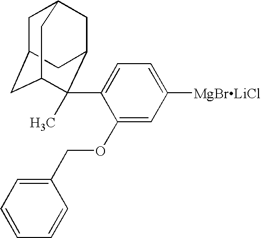 | 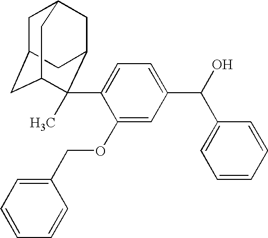 | 88 |
| 13 | 34 | 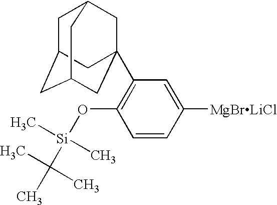 | 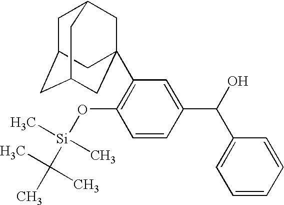 | 79 |
| 14 | 35 | 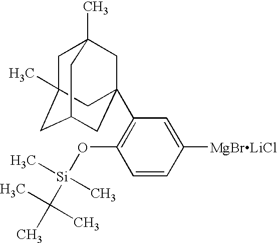 | 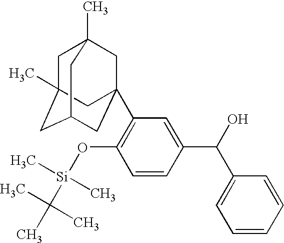 | 80 |
| 15 | 36 | 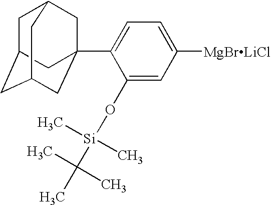 | 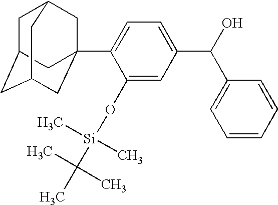 | 76 |
| 16 | 37 | 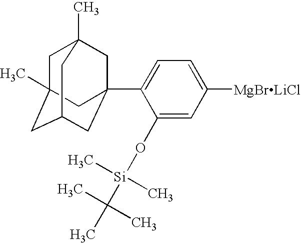 | 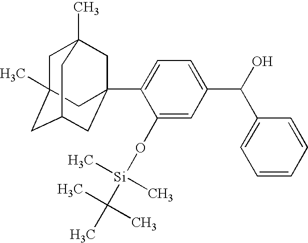 | 74 |
| 17 | 38 | 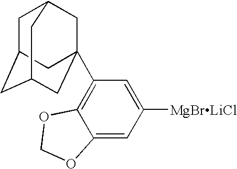 | 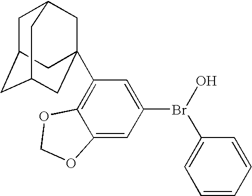 | 81 |
| 18 | 39 | 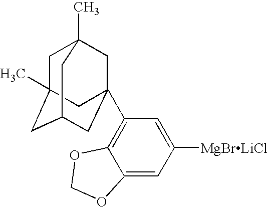 | 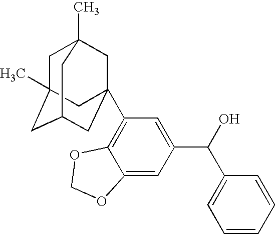 | 84 |
| 19 | 40 | 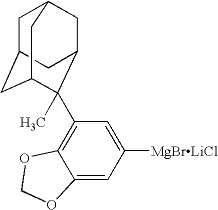 | 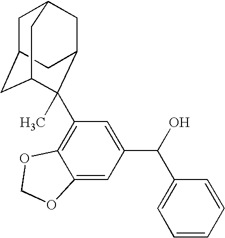 | 79 |
| 20 | 41 | 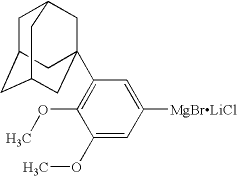 | 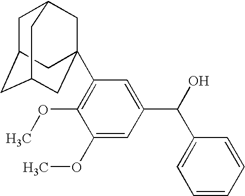 | 82 |
| 21 | 42 | 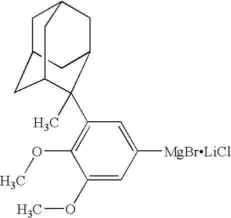 | 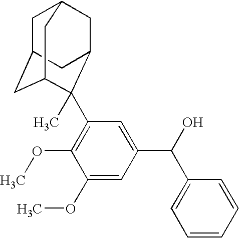 | 77 |

*Example number
**Gas chromatography data

### EXAMPLE 24

Reaction is performed as described in Example 11. As the starting adamantylarylhalide 5.36 g (0.016 M) of 2-[2-(2-methyladamantyl)]-4-bromoanisole is used.

Yield, according to gas chromatography data is 84%.

### EXAMPLE 25

Reaction is performed as described in Example 11. As the adamantylarylhalide 5.14 g (0.016 M) of 2-(1-adamantyl)-5-bromoanisole is used.

Yield, according to gas chromatography data is 92%.

### EXAMPLE 26

Reaction is performed as described in Example 11. As the starting adamantylarylhalide 5.6 g (0.016 M) of 2-[1-(3,5-dimethyladamantyl)]-5-bromoanisole is used.

Yield, according to gas chromatography data is 91%.

### EXAMPLE 27

Reaction is performed as described in Example 11. As the starting adamantylarylhalide 5.36 g (0.016 M) of 2-[2-(2-methyladamantyl)-5-bromoanisole is used.

Yield, according to gas chromatography data is 90%.

### EXAMPLE 28

Reaction is performed as described in Example 11. As the adamantylarylhalide 6.35 g (0.016 M) of 3-(1-adamantyl)-4-benzyloxybrombenzene is used.

Yield, according to gas chromatography data is 92%.

### EXAMPLE 29

Reaction is performed as described in Example 11. As the starting adamantylarylhalide 6.8 g (0.016 M) of 3-[1-(3,5-dimethyladamantyl)]-4-benzyloxybrombenzene is used.

Yield, according to gas chromatography data is 90%.

### EXAMPLE 30

Reaction is performed as described in Example 11. As the starting adamantylarylhalide 6.58 g (0.016 M) of 3-[2-(2-methyladamantyl)]-4-benzyloxybrombenzene is used.

Yield, according to gas chromatography data is 88%.

### EXAMPLE 31

Reaction is performed as described in Example 11. As the adamantylarylhalide 6.35 g (0.016 M) of 3-benzyloxy-4-(1-adamantyl)brombenzene is used.

Yield, according to gas chromatography data is 92%.

### EXAMPLE 32

Reaction is performed as described in Example 11. As the adamantylarylhalide 6.8 g (0.016 M) of 3-benzyloxy-4-[1-(3,5-dimethyladamantyl)brombenzene is used.

Yield, according to gas chromatography data is 87%.

### EXAMPLE 33

Reaction is performed as described in Example 11. As the adamantylarylhalide 6.58 g (0.016 M) of 3-benzyloxy-4-[2-(2-methyladamantyl)brombenzene is used.

Yield, according to gas chromatography data is 88%.

### EXAMPLE 34

Reaction is performed as described in Example 11. As the adamantylarylhalide 6.74 g (0.016 M) of 3-(1-adamantyl)-4-[1-(tert-butyldimethylsilyloxy)]brombenzene is used.

Yield, according to gas chromatography data is 79%.

### EXAMPLE 35

Reaction is performed as described in Example 11. As the starting adamantylarylhalide 7.18 g (0.016 M) of 3-[1-(3,5-dimethyladamantyl)]-4-(tert-butyldimethylsilyloxy)bromobenzene is used.

Yield, according to gas chromatography data is 80%.

### EXAMPLE 36

Reaction is performed as described in Example 11. As the adamantylarylhalide 6.74 g (0.016 M) of 3-(tert-butyldimethylsilyloxy)-4-(1-adamantyl)brombenzene is used.

Yield, according to gas chromatography data is 76%.

### EXAMPLE 37

Reaction is performed as described in Example 11. As the adamantylarylhalide 7.18 g (0.016 M) of 3-(tert-butyldimethylsilyloxy)-4-[1-(3,5-dimethyladamantyl)brombenzene is used.

Yield, according to gas chromatography data is 74%.

### EXAMPLE 38

Reaction is performed as described in Example 11. As the adamantylarylhalide 5.36 g (0.016 M) of 3,4-methylenedioxy-5-(1-adamantyl)brombenzene is used.

Yield, according to gas chromatography data is 81%.

### EXAMPLE 39

Reaction is performed as described in Example 11. As the adamantylarylhalide 5.81 g (0.016 M) of 3,4-methylenedioxy-5-[1-(3,5-dimethyladamantyl)brombenzene is used.

Yield, according to gas chromatography data is 84%.

### EXAMPLE 40

Reaction is performed as described in Example 11. As the adamantylarylhalide 5.58 g (0.016 M) of 3,4-methylenedioxy-5-[2-(2-methyladamantyl)brombenzene is used.

Yield, according to gas chromatography data is 79%.

### EXAMPLE 41

Reaction is performed as described in Example 11. As the adamantylarylhalide 5.62 g (0.016 M) of 3-(1-adamantyl)-5-bromoveratrol is used.

Yield, according to gas chromatography data is 82%.

### EXAMPLE 42

Reaction is performed as described in Example 11. As the starting adamantylarylhalide 5.84 g (0.016 M) of 3-[2-(2-methyladamantyl)-5-bromoveratrol is used.

Yield, according to gas chromatography data is 77%.

The aforementioned results show that by use of lithium chloride in the reaction of preparing adamantylarylmagnesium halides by action of magnesium metal on adamantylarylhalide in dry tetrahydrofuran stable high yields of the desired product are obtained.

The present method for preparation of substituted adamantylarylmagnesium halides is characterized by stable high yields, technological feasibility and possibility to scale up the reaction volume.

1-7. (canceled)

8. A method for preparing substituted adamantylarylmagnesium halide comprising reacting a substituted adamantylarylhalide with magnesium in an aprotic inert solvent (direct Grignard reaction) in the presence of an anhydrous lithium salt.

9. The method of claim 8, wherein the reaction is conducted at a temperature from about −70° C. to about 80° C.

10. The method of claim 9, wherein the reaction is conducted at a temperature from about 20° C. to about 70° C.

11. The method of claim 8, wherein the aprotic inert solvent is tetrahydrofuran.

12. The method of claim 8, wherein the anhydrous lithium salt is anhydrous lithium chloride, lithium bromide, lithium iodide, lithium sulfate, lithium perchlorate, or lithium tetrafluoroborate.

13. The method of claim 12, wherein the anhydrous lithium salt is anhydrous lithium chloride.

14. The method of claim 8, wherein the anhydrous lithium salt is used in a stoichiometric ratio to a substituted adamantylarylhalide in range from 0.1 to 5.0 mol per mol.

15. The method of claim 8, wherein the anhydrous lithium salt is used in an optimal stoichiometric ratio to a substituted adamantylarylhalide in range from 1.2 to 1.5 mol per mol.

16. A method for preparing a compound of formula (I) 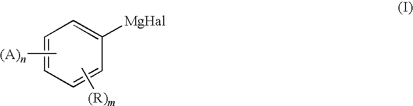
wherein
A is (1-adamantyl) or (2-adamantyl) which can be optionally substituted with from zero to six substituents each independently selected from OR¹, NR¹R², alkyl, alkenyl, alkynyl, cycloalkyl, cycloalkylalkyl, bicycloalkyl, bicycloalkylalkyl, alkylthioalkyl, arylalkylthioalkyl, cycloalkenyl, aryl, aralkyl, heteroaryl, heteroarylalkyl, cycloheteroalkyl and cycloheteroalkylalkyl;
R¹ and R² are each independently selected from alkyl, alkenyl, alkynyl, is aryl and heteroaryl;
Hal is Cl, Br or I, preferably Br;
R is:
H, Cl, F, CF₃ or fluorinated C₁-C₁₀alkyl, C₁-C₁₀alkylC₂-C₁₀alkenyl, C₂-C₁₀alkynyl, C₁-C₁₀alkoxy, or two R groups taken together, form a alkylenedioxy group, —OSiR³R⁴R⁵, —(CH₂)ₜ(C₆-C₁₀aryl), —(CH₂)ₜ(4-10 membered heterocyclic), wherein t is an integer from 0 to 5; said alkyl group optionally includes hetero moieties selected from O, S and —N(R⁶), wherein R³, R⁴, R⁵ are each independently C₁-C₁₀alkyl,
said R aryl and heterocyclic groups are optionally fused to a C₆-C₁₀aryl group, a saturated C₅-C₅cyclic group, or a 5-10 membered heterocyclic group,
the —(CH₂)ₜ— moieties of the foregoing R groups optionally include a carbon-carbon carbon double or triple bond where t is an integer from 2 to 5; and the foregoing R groups, except H, are optionally substituted by 1 to 3 R⁶ groups; R⁶ is C₁-C₁₀alkyl or C₁-C₁₀alkoxy;
n is 1 or 2;
m is 0 to 3;
comprising reacting a compound of formula (II) 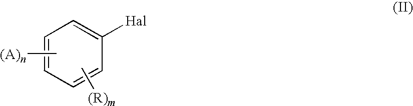
wherein A, Hal, R, n and m are as defined for formula (I) with magnesium in an aprotic inert solvent (direct Grignard reaction) in the presence of an anhydrous lithium salt.

17. The method of claim 16, wherein Hal is Br.
